(19) United States
(12) Patent Application Publication
(10) Pub. No.: US 2004/0198461 A1
(43) Pub. Date: Oct. 7, 2004

(54) Method and apparatus for answering incoming calls at a mobile communication device

(76) Inventor: Daniel J. Coombes, Glen Ellyn, IL (US)

Correspondence Address: Scott M. Garrett, Motorola, Inc., Law Department, 8000 West Sunrise Boulevard, Fort Lauderdale, FL, 33322, US

(21) Appl. No.: 10/241,916

(22) Filed: Sep. 12, 2002

(51) Int. Cl. H04B 1/38

(52) U.S. Cl. 455/567; 455/415; 455/412.1

(57) ABSTRACT

A mobile communication device receives an incoming call signal (204), and activates a call alert function (206) to alert a user of the mobile communication device of the incoming call. The mobile communication device also presents the user with the alternative options (208) of auto-answering the incoming call, or answering the call normally. If the auto-answer option is chosen (210), the mobile communication device answers the call and transmits a pre-recorded greeting message (212) to the calling party, then puts the call on hold (214) until the user is ready to speak with the calling party. This avoids the disruption of having to answer the call immediately.

### TECHNICAL FIELD

This invention relates in general to mobile communication devices, and more particularly to methods of answering incoming calls received at a mobile communication device.

### BACKGROUND OF THE INVENTION

Mobile communication devices are in widespread use for both business and personal communications. Mobile communication systems and mobile communication devices make it easier to get in touch with others, including people who use mobile devices and services. Many people would consider mobile communication an essential. In some ways, however, mobile communications has produced undesirable consequences. For example, in many public areas users of mobile communication devices are requested to turn off the device, or place it in a silent mode so that incoming calls do not create a distraction. It is also not uncommon to receive a call at a time when it is inconvenient or inappropriate to answer, such as during an important meeting.

A typical routine employed by users of mobile communication devices is to leave the mobile communication device on, and if a call is received at an inconvenient time they stop what they are doing to answer the call and inform the calling party that they will call back. Having to pause and answer a call, even if it is simply to inform the calling party that they will be called back, can be disruptive and inappropriate, especially if the user is presently engaged in an activity that cannot be conveniently interrupted when the call is made. Alternatively, the user may forward calls to a voice mailbox to avoid being disturbed, or the call may default to the voice mailbox if the call is not answered within a specified period of time. However, the voice mailbox alternative is not desirable if the user is expecting an important call, and needs to respond in a timely fashion.

### BRIEF DESCRIPTION OF THE DRAWINGS

FIG. 1 shows a block diagram schematic of a mobile communication device, in accordance with the invention;

FIG. 2 shows a flow chart diagram of a method for automatically answering an incoming call, in accordance with the invention; and

FIG. 3 shows a flow chart method of a preferred embodiment of a method for automatically answering an incoming call, in accordance with the invention.

### DETAILED DESCRIPTION OF A PREFERRED EMBODIMENT

While the specification concludes with claims defining the features of the invention that are regarded as novel, it is believed that the invention will be better understood from a consideration of the following description in conjunction with the drawing figures, in which like reference numerals are carried forward. A brief description of the prior art is also thought to be useful.

The invention solves the problem of receiving incoming calls at a mobile communication device at an inconvenient time by providing a means for selectively and automatically answering the incoming call. The mobile communication device will receive the incoming call signal in accordance with present practice, but the mobile communication device allows the user to either take the call, or upon receiving an affirmative indication from the user, automatically answer the call and transmit a pre-recorded greeting message, then hold the call until the user is able to speak with the caller. The pre-recorded greeting message may be a standard, default message, or a message recorded by the user specifically for an anticipated calling party.

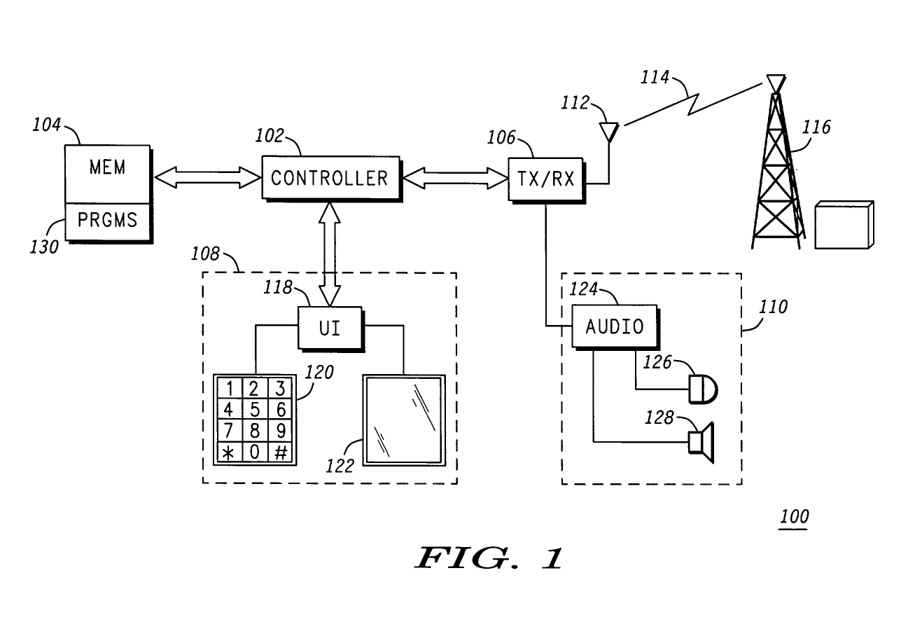

Referring now to FIG. 1, there is shown a block diagram schematic 100 of a mobile communication device, in accordance with the invention. The mobile communication device comprises a controller 102, memory 104, transceiver 106, user interface 108, and audio section 110. The controller controls the operation of the mobile communication device in accordance with software instructions in a conventional manner, and further in accordance with the invention as taught herein. The memory 104 comprises both volatile and non-volatile RAM, and possibly ROM. Instruction code used by the controller for operating the mobile communication device is stored in the memory, and the memory is also used by the controller for calculating various parameters used during operation, and is further used for storing semi-permanent data such as phone numbers, for example.

The transceiver may be a conventional transceiver, and comprises both transmitter and receiver sections for respectively modulating and demodulating radio signals, and it includes an antenna 112. The transceiver operates to establish a radio frequency link 114 to a base station 116 to send and receive information according to an air interface. Furthermore, in the preferred embodiment, the transceiver comprises digital signal processing means for performing digital communications, and for encoding and decoding voice signals. The user interface 108 is a means for the user of the mobile communication device to control the operation of the mobile communication device, and provides an interface controller 118, a keypad 120 for entering commands and information, and a display 122 for displaying information and providing visual feedback to the user. The interface controller comprises, for example, a means for reading the keypad and indicating to the controller what information is being entered thereby, and a display driver for controlling the display. The interface controller may comprise software located in the memory 104, that is executed by the controller 102 in accordance with the teachings herein. The audio section 110 includes an audio controller 124, and audio transducers such as a microphone 126 and a speaker 128. The audio controller performs signal conditioning, amplification, and so on, as is conventional, and preferably performs analog to digital and digital to analog conversions, as is common in the art.

According to the invention, a pre-recorded greeting message (PRGM) 130 is provided in digital form in the memory 104. The PRGM is a voice message similar to that used on telephone answering machines. It may be provided by the manufacturer of the mobile communication device at the time of manufacture, or in a preferred embodiment, it is recorded by the user or owner of the mobile communication device. An example of a PRGM would be “please hold, I will speak with you in a moment,” or some other appropriate phrase.

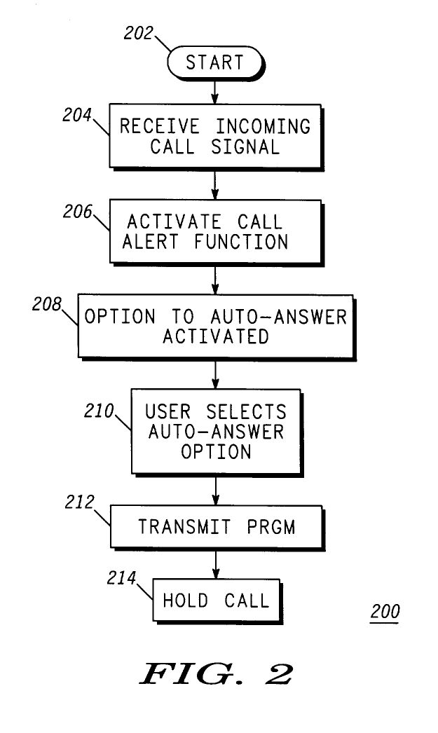

Referring now to FIG. 2, there is shown a flow chart diagram 200 of a method for automatically answering an incoming call, in accordance with the invention. At the start 202 of the process, the step of providing a PRGM in the mobile communication device has been performed, either at the time of manufacture, or subsequently. The PRGM is stored in the communication system, for example in the mobile communication device or perhaps equally effective in the communication system infrastructure. In the preferred embodiment, the PRGM is in the memory of the mobile communication device, and in a compressed form. Compression can be achieved by storing the PRGM in an encoded form such as is achieved using vector sum excited linear predictive (VSELP) encoding techniques. Compression greatly reduces the memory space required to store the PRGM. Furthermore, it is assumed that the mobile communication device is powered on and registered for service. Some time thereafter, another party wishes to call the user of the mobile communication device. Accordingly, the base station sends an incoming call signal, and the mobile communication device performs the step of receiving the incoming call signal (204) from the base station. In response to receiving the incoming call signal, the mobile communication device then performs the step of activating a call alert means (206) of the mobile communication device. The call alert means may be any one of several conventional means, such as playing an audio signal over the speaker, or energizing a vibration device for so-called “silent ringing”, for example. Once the call alert means has been activated, the user has the option of auto-answering the call, or answering it normally. The mobile communication device has been provided with a means for selecting the auto-answer feature option on the mobile communication device. The means for selecting may be, for example, a button provided specifically for enabling the auto-answer feature, but preferably, upon receiving the incoming call signal, the mobile communication device displays a message to the user offering the option. The user then presses one of two soft keys to select the desired operation and proceed. A soft key is a button provided on the mobile communication device in close proximity to a portion of the display where various messages can be shown, indicating that if the user presses the button at that time, a specific function or action is taken by the mobile communication device. The function activated by the soft key therefore changes depending on the state of the mobile communication device. The option to auto-answer the incoming call is activated (208) by the user. According to the invention, once the call alert is activated, the user selects (210) the auto-answer feature by, for example, pressing the designated button or soft key. In response to a user selecting the auto-answer feature option, the mobile communication device answers the incoming call as it would normally do, but does not transmit audio signals received at the microphone of the mobile communication device. Instead, the mobile communication device transmits (212) the pre-recorded greeting message to the calling party, and holds the call (214). That is, the mobile communication device puts the calling party on hold, and maintains the call in an “in progress” state. However, the mobile communication device does not transmit any audio signal from the microphone, and preferably doesn't activate the speaker or earpiece while the call is on hold. At some point thereafter, the user may then resume the call by, for example, pressing a button, indicating that the user now desires to commence with the call that is on hold. The mobile communication device then activates the microphone and speaker, and the call commences normally.

The auto-answer feature may be enhanced in one of several ways. For example, the PRGM may be provided at the time of manufacture, but more preferably the user of the mobile communication device records the PRGM to provide a PRGM in the user's own voice. This is accomplished by providing the mobile communication device with appropriate software to accept an input from the user indicating the desire to record a PRGM, then activating the microphone while the user speaks, and digitizing the user's voice and storing it in the memory of the mobile communication device. Optionally, the PRGM so recorded can be played back, if desired, through the speaker, so that the user can determine if the PRGM sounds as intended.

Additionally, it is common for the mobile communication device to store calling numbers and names of parties the user frequently calls. It is contemplated that different PRGMs may be recorded to correspond with any of the stored numbers so that when the calling party is one for which the user is familiar with, the auto-answer feature provides a personalized PRGM to the calling party. In the absence of a custom PRGM, a default PRGM is used. Thus, the method for automatically answering an incoming call comprises providing a plurality of different PRGMs. The incoming call signal includes a calling party identifier, and the mobile communication device then identifies which one of the plurality of calling party names the calling party identifier corresponds. The method further comprises displaying a calling party name corresponding to the calling party identifier, if the calling party identifier corresponds to a calling party name stored in the memory of the mobile communication device. After determining the calling party's identity, the mobile communication device transmits a PRGM corresponding to the calling party identifier, if one has been provided, otherwise a default PRGM is transmitted, or a PRGM of the user's choice may be transmitted.

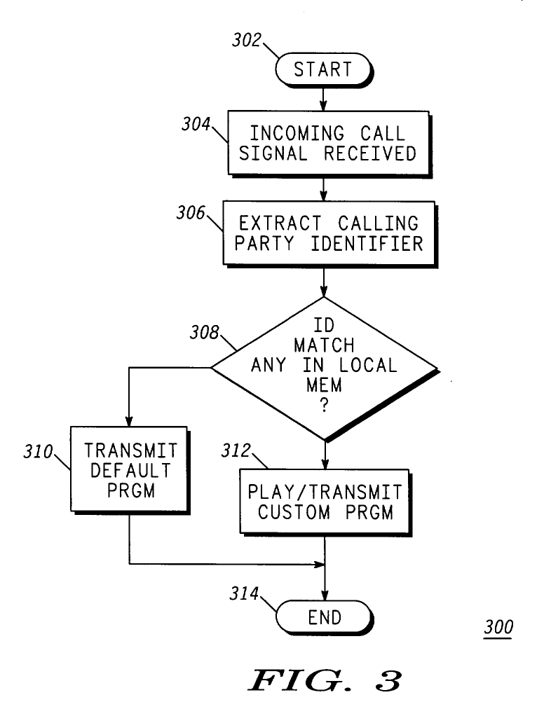

The alternative method of auto-answering by providing custom PRGMs corresponding to different calling parties is shown in FIG. 3. Referring now to FIG. 3, there is shown a flow chart diagram of an alternative method auto-answering an incoming call 300 at a mobile communication device. The alternative method starts (302) in the same way and under the same conditions as the method shown and discussed in reference to FIG. 2. Here, the mobile communication device has been provided with a plurality of PRGMs, including a default PRGM and a plurality of custom PRGMs. The custom PRGMs have been recorded by the user of the mobile communication device to be used under a particular circumstance, or for use with a particular caller that the user anticipates will call at some time in the future. First the incoming call signal is received (304), and a calling party identifier is included in the incoming call signal. The mobile communication device activates the call alert function as in FIG. 2, and waits for input from the user to decide between answering the call normally, or auto-answering the call with a PRGM. Assuming the user indicates the latter choice, the mobile communication device extracts the calling party identifier (306), and searches (308) its memory for a match. For example, it is common to transmit the phone number of the calling party, in which case the calling party's phone number can act as the calling party identifier. If no match is found, then a default PRGM can be transmitted (310), otherwise the corresponding custom PRGM is transmitted (312), and the auto-answer ends (314) as normal by placing the call on hold until the user is ready to take the call.

Thus, the invention provides for a means and apparatus for auto-answering an incoming call at a mobile communication device. This allows the user of the mobile communication device to auto-answer calls and put them on hold briefly until the user can attend to the call. This will be of benefit, for example, when the user is speaking at a meeting and cannot simply stop to answer a call, but does wish to speak to the calling party. While the preferred embodiments of the invention have been illustrated and described, it will be clear that the invention is not so limited. Numerous modifications, changes, variations, substitutions and equivalents will occur to those skilled in the art without departing from the spirit and scope of the present invention as defined by the appended claims.

What is claimed is:

1. A method for automatically answering an incoming call received at a mobile communication device, comprising the steps of:
providing a pre-recorded greeting message;
receiving an incoming call signal from a base station at the mobile communication device;
activating a call alert means of the mobile communication device in response to receiving the incoming call signal;
providing a means for selecting an auto-answer feature option on the mobile communication device;
in response to a user selecting the auto-answer feature option, answering the incoming call automatically at the mobile communication device;
transmitting the pre-recorded greeting message to the calling party, performed automatically by the mobile communication device; and
holding the call.

2. A method for automatically answering an incoming call as defined in claim 1, wherein the step of providing a pre-recorded greeting message comprises recording the pre-recorded greeting message, performed by the user of the mobile communication device.

3. A method for automatically answering an incoming call as defined in claim 1, wherein the step of providing a means for selecting the auto answer feature comprises providing a soft key for selecting the auto answer feature.

4. A method for automatically answering an incoming call as defined in claim 1, wherein the step of receiving an incoming call signal includes receiving a calling party identifier, the method further comprises displaying a calling party name corresponding to the calling party identifier.

5. A method for automatically answering an incoming call as defined in claim 4, wherein the step of providing the pre-recorded greeting message comprises providing a plurality of different pre-recorded greeting messages.

6. A method for automatically answering an incoming call as defined in claim 5, wherein each of the plurality of different greeting messages correspond to one of a plurality of calling party names stored in the memory of the mobile communication device, the step of transmitting the pre-recorded greeting message comprises:
identifying which one of the plurality of calling party names the calling party identifier corresponds with, and
transmitting the pre-recorded greeting message corresponding to the calling party identifier.

7. A method for automatically answering an incoming call as defined in claim 6, wherein the step of transmitting further comprises, if the calling party identifier does not correspond to any one of the plurality of calling party names, transmitting a default pre-recorded greeting message.

8. A method for auto-answering an incoming call at a mobile communication device, the mobile communication device having a pre-recorded greeting message stored in a memory of the mobile communication device, the mobile communication device having been placed in an auto-answer mode and having received an incoming call signal from a base station, the method comprising:
transmitting the pre-recorded greeting message; and
holding the incoming call until a user of the mobile communication device wishes to commence with the incoming call.

9. A method for auto-answering an incoming call as defined in claim 8, wherein the incoming call signal contains a calling party identifier, the mobile communication device contains a plurality of custom pre-recorded greeting messages, each of the plurality of pre-recorded greeting messages corresponding to one of a plurality of calling party names stored in the mobile communication device, the step of transmitting comprising:
matching the calling party identifier received with the incoming call signal with one of the plurality of calling party names stored in the mobile communication device; and
transmitting the custom pre-recorded message corresponding to the matching calling party name.
